(19) United States
(12) Patent Application Publication
(10) Pub. No.: US 2024/0289657 A1
(43) Pub. Date: Aug. 29, 2024

(54) INFORMATION PROCESSING DEVICE, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventors: Miho KAWAMURA, Tokyo (JP); Yuichi SASAKI, Tokyo (JP)

(73) Assignee: Mitsubishi Electric Corporation, Tokyo (JP)

(21) Appl. No.: 18/656,785

(22) Filed: May 7, 2024

Related U.S. Application Data
(63) Continuation of application No. PCT/JP2021/045819, filed on Dec. 13, 2021.

(51) Int. Cl. G06N 7/01

(52) U.S. Cl. CPC G06N 7/01

(57) ABSTRACT

An information processing device that stores a log-likelihood matrix consisting of log-likelihoods as components arranged in ascending order of lengths of unit series and timesteps; that generates a shifted log-likelihood matrix by performing a shifting process of shifting the log-likelihoods to align along each line in ascending order of the lengths when the lengths and the timesteps are each increased by one unit; that generates a successive-generation probability matrix by adding the log-likelihoods from the top of each line to the respective components in the shifted log-likelihood matrix; a matrix-rotation operating unit that generates a shifted successive-generation probability matrix by shifting the successive generation probabilities in the successive-generation-probability matrix in such a manner that shift destinations and shift sources of components whose values have been shifted through the shifting process; and that calculates forward probabilities using the shifted successive-generation probability matrix.

### CROSS REFERENCE TO RELATED APPLICATION

This application is a continuation application of International Application No. PCT/JP2021/045819 having an international filing date of Dec. 13, 2021.

### BACKGROUND OF THE INVENTION

### 1. Field of the Invention

The disclosure relates to an information processing device, a non-transitory computer-readable storage medium, and an information processing method.

### 2. Description of the Related Art

Conventionally, there are known devices that segment continuous time series data into unit series without supervision on the basis of hidden semi-Markov models of Gaussian processes.

For example, Patent Literature 1 discloses a forward filtering-backward sampling (FFBS) unit that executes FFBS processing to specify multiple pieces of unit series data obtained by segmenting time series data and that specifies the classes for classifying the unit series data, and an information processing device that executes blocked Gibbs sampler (BGS) to adjust parameters to be used when the FFBS executing unit specifies the unit series data and the classes. Such information processing devices can be used as learning devices to learn the movements of robots.

In Patent Literature 1, forward filtering obtains a forward probability α[t][k][c] in which a unit series xⱼ having a length k is classified into a class c, with a certain timestep t as the endpoint. Backward sampling is performed to obtain the length and class of the unit series in backward order in accordance with the forward probability α[t][k][c]. This determines the length k of the unit series xⱼ obtained by segmenting an observation series S and the class c of each of the unit series xⱼ.
Patent Literature 1: International Publication No. 2018/047863

### SUMMARY OF THE INVENTION

In the conventional technique, as forward filtering, repeated calculation is performed regarding each of the following three variables: timestep t, length k of a unit series xⱼ, and class c.

Since the calculation is performed for each variable, the calculation takes time, and it is difficult to tune the hyperparameters of a Gaussian process-hidden semi-Markov model (GP-HSMM) or perform real-time work analysis at the assembly site.

Accordingly, it is an object of one or more aspects of the disclosure is to enable efficient calculation of forward probabilities.

An information processing device according to an aspect of the disclosure includes: a processor to execute a program; and a memory to store the program which, when executed by the processor, performs processes of, storing a log-likelihood matrix in which log-likelihoods are arranged as components in ascending order of lengths of unit series predetermined to divide a time series of a predetermined event and timesteps for combinations of predicted values predicting the event for each length up to a maximum length and variances of the predicted values, the log-likelihoods being obtained by converting likelihoods into logarithms, the likelihoods being probabilities of observation values obtained from the event at the respective timesteps being generated; generating a shifted log-likelihood matrix by performing a shifting process of shifting the log-likelihoods other than log-likelihoods at the top of each line in the log-likelihood matrix in such a manner that the log-likelihoods are aligned along each line in ascending order of the lengths when the lengths and the timesteps are each increased by one unit; generating a successive-generation probability matrix by adding the log-likelihoods from the top of each of the lines to the respective components in the shifted log-likelihood matrix, to calculate successive generation probabilities of the respective components; generating a shifted successive-generation probability matrix by shifting the successive generation probabilities in the successive-generation-probability matrix in such a manner that shift destinations and shift sources of components whose values have been shifted through the shifting process; and calculating a forward probability of a unit series having a certain length to be classified into a certain class with a certain timestep being an endpoint by using a value obtained by adding the successive generation probabilities up to the respective components in ascending order of the lengths at the respective timesteps in the shifted successive-generation probability matrix.

A non-transitory computer-readable storage medium storing a program according to an aspect of the disclosure that causes a computer to execute processes comprising: storing a log-likelihood matrix in which log-likelihoods are arranged as components in ascending order of lengths of unit series predetermined to divide a time series of a predetermined event and timesteps for combinations of predicted values predicting the event for each length up to a maximum length and variances of the predicted values, the log-likelihoods being obtained by converting likelihoods into logarithms, the likelihoods being probabilities of observation values obtained from the event at the respective timesteps being generated; generating a shifted log-likelihood matrix by performing a shifting process of shifting the log-likelihoods other than log-likelihoods at the top of each line in the log-likelihood matrix in such a manner that the log-likelihoods are aligned along each line in ascending order of the lengths when the lengths and the timesteps are each increased by one unit; generating a successive-generation probability matrix by adding the log-likelihoods from the top of each of the lines to the respective components in the shifted log-likelihood matrix, to calculate successive generation probabilities of the respective components; generating a shifted successive-generation probability matrix by shifting the successive generation probabilities in the successive-generation-probability matrix in such a manner that shift destinations and shift sources of components whose values have been shifted through the shifting process; and calculating a forward probability of a unit series having a certain length to be classified into a certain class with a certain timestep being an endpoint by using a value obtained by adding the successive generation probabilities up to the respective components in ascending order of the lengths at the respective timesteps in the shifted successive-generation probability matrix.

An information processing method according to an aspect of the disclosure includes: using a log-likelihood matrix in which log-likelihoods are arranged as components in ascending order of lengths of unit series predetermined to divide a time series of a predetermined event and timesteps for combinations of predicted values predicting the event for each length up to a maximum length and variances of the predicted values, the log-likelihoods being obtained by converting likelihoods into logarithms, the likelihoods being probabilities of observation values obtained from the event at the respective timesteps being generated; generating a shifted log-likelihood matrix by performing a shifting process of shifting the log-likelihoods other than log-likelihoods at the top of each line in the log-likelihood matrix in such a manner that the log-likelihoods are aligned along each line in ascending order of the lengths when the lengths and the timesteps are each increased by one unit; generating a successive-generation probability matrix by adding the log-likelihoods from the top of each of the lines to the respective components in the shifted log-likelihood matrix, to calculate successive generation probabilities of the respective components; generating a shifted successive-generation probability matrix by shifting the successive generation probabilities in the successive-generation-probability matrix in such a manner that shift destinations and shift sources of components whose values have been shifted through the shifting process; and calculating a forward probability of a unit series having a certain length to be classified into a certain class with a certain timestep being an endpoint by using a value obtained by adding the successive generation probabilities up to the respective components in ascending order of the lengths at the respective timesteps in the shifted successive-generation probability matrix.

According to one or more aspects of the disclosure, forward probabilities can be calculated efficiently.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of an information processing device according to an embodiment;

FIG. 2 is a schematic diagram illustrating an example of a log-likelihood matrix;

FIG. 3 is a block diagram schematically illustrating a configuration of a computer;

FIG. 4 is a flowchart illustrating operation performed by the information processing device;

FIG. 5 is a schematic diagram for describing a multidimensional array of log-likelihood matrices;

FIG. 6 is a schematic diagram for explaining left rotation operation;

FIG. 7 is a schematic diagram illustrating an example of a rotated log-likelihood matrix;

FIG. 8 is a schematic diagram illustrating an example of successive-generation probability matrix;

FIG. 9 is a schematic diagram for explaining right rotation operation;

FIG. 10 is a schematic diagram illustrating an example of a rotated successive-generation probability matrix; and

FIG. 11 is a schematic diagram illustrating a graphical model using unit series of an observation series, classes of the unit series, and a parameter of a Gaussian process of the classes c in the above Gaussian process.

### DETAILED DESCRIPTION OF THE INVENTION

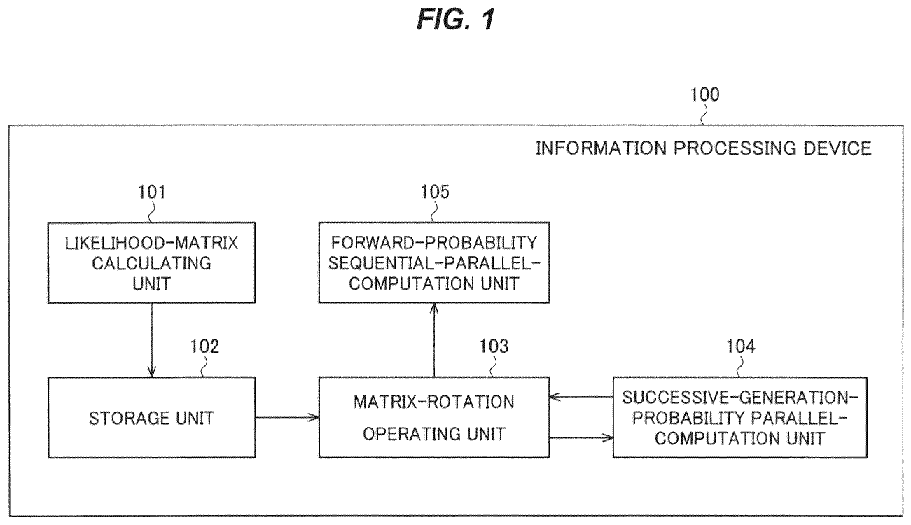

FIG. 1 is a block diagram schematically illustrating a configuration of an information processing device 100 according to an embodiment.

The information processing device 100 includes a likelihood-matrix calculating unit 101, a storage unit 102, a matrix-rotation operating unit 103, a successive-generation-probability parallel-computation unit 104, and a forward-probability sequential-parallel-computation unit 105.

A Gaussian process will now be explained.

An observation series S represents a change in observation values over time.

The observation series S can be segmented by classes predetermined on the basis of waveforms having similar shapes, and unit series xⱼ representing the respective waveforms having predetermined shapes can be classified.

Specifically, values obtained from a time series of a predetermined event are the observation values obtained for the respective lengths, up to a maximum length, and timesteps of the predetermined unit series for dividing the time series.

For a method of performing such segmentation, for example, a model in which one state represents one continuous unit series xⱼ by setting the output of a hidden semi-Markov model to a Gaussian process can be used.

That is, each class can be represented as a Gaussian process, and the observation series S is generated by joining unit series xⱼ generated from the respective classes. Thus, by learning parameters of the model only on the basis of the observation series S, it is possible to estimate, without supervision, nodes of segmentation where the observation series S is segmented into unit series xⱼ and the classes of the unit series xⱼ.

Here, if it is assumed that time series data is generated through a hidden semi-Markov model having an output distribution as a Gaussian process, classes cⱼ are determined by the following equation (1), and unit series xⱼ are generated by the following equation (2).

cⱼ˜P(c|cⱼ₋₁) (1)

xⱼ˜GP(x|X_{c}_{ⱼ}) (2)

Then, by the hidden semi-Markov model and the estimation of parameters X_{c} of the Gaussian process expressed by equation (2), the observation series S can be segmented into unit series xⱼ, and each of the unit series xᵢ can be classified into a class c.

For example, output values xᵢ at timesteps I of the unit series are learned through Gaussian process regression and thus are represented as a continuous trajectory. Therefore, in a Gaussian process, when a sets (I,x) of output values x at timesteps I of unit series belonging to the same class are obtained, the predicted distribution of output values x′ at timesteps I′ is a Gaussian distribution expressed by the following equation (3).

p(x′|i′,x,i)∝N(k^{T}C⁻¹i,c−k^{T}C⁻¹k) 3)

In equation (3), k is a vector having k(iₚ,i_{q}) as an element, c is a scalar of k(I′,I′), and C is a matrix having elements as expressed by equation (4) below.

$$C ( {i}_{p} , {i}_{q} ) = k ( {i}_{p} , {i}_{q} ) + {β}^{- 1} δ nm \qquad ( 4 )$$

In equation (4), R is a hyperparameter representing the accuracy of noise contained in the observation values.

In a Gaussian process, the use of kernels allows learning even when the series data changes in a complex manner. For example, a Gaussian kernel expressed by the following equation (5), which is widely used in Gaussian process regression, can be used. In equation (5), θ₀, θ₂, and θ₃ are kernel parameters.

$$k ( {i}_{p} , {i}_{q} ) = {θ}_{0} exp ( - \frac{1}{2} {‖ {i}_{p} - {i}_{q} ‖}^{2} + {θ}_{2} + {θ}_{3} {i}_{p} {i}_{q} ) \qquad ( 5 )$$

If it is assumed that an output value xᵢ is a multidimensional vector (xᵢ=x_{i,0}, xᵢ, 1, . . . ), and each dimension is generated independently, a probability GP that is generated from a Gaussian process in which an observation value xᵢ at a timestep I corresponds to a class c is determined by computing the following equation (6).

$$GP ( {x}_{i} \vert {X}_{c} ) = p ( {x}_{i , 0} \vert i , {X}_{c} , {I}_{c} ) \times p ( {x}_{i , 1} \vert i , {X}_{c} , {I}_{c} ) \times p ( {x}_{i , 2} \vert i , {X}_{c} , {I}_{c} ) \qquad ( 6 )$$

By using the probability GP determined in this way, similar unit series can be classified into the same class.

In a hidden semi-Markov model, since the length of a unit series xⱼ classified into a class c depending on that class c, it is necessary to estimate the length of the unit series xⱼ when the parameter X_{c} of the Gaussian process is estimated.

The length k of the unit series xⱼ can be determined by sampling the probability of a unit series xⱼ having a length k being classified into a class c, with the endpoint being a data point of a timestep t. Therefore, in order to determine the length k of the unit series xⱼ, it is necessary to calculate the probabilities of various combinations of lengths k and all classes c by using forward filtering-backward sampling (FFBS), as described below.

By estimating the parameter X_{c} of the Gaussian process, a unit series xⱼ can be classified into a class c.

FFBS will now be explained.

For example, in FFBS, a probability α[t][k][c], which is the probability of a unit series xⱼ having a length k being classified into a class c, can be calculated in the forward direction with a data point of a timestep t as the endpoint, and the length k and the class c of the unit series xⱼ can be determined through backward sampling in accordance with the probability α[t][k][c]. For example, the forward probability α[t][k][c] can be calculated recursively by marginalizing the possibility of transition from a timestep t−k to a timestep t, as expressed by equation (11) below.

For example, for the possibility of transitioning to a unit series xⱼ of length k=2 and class c=2 at a timestep t, the possibility of this being a transition from a unit series xⱼ of length k=1 and class c=1 at a timestep t−2 is p(2|1)α[t−2][1][1].

The possibility of this being a transition from a unit series xⱼ of length k=2 and class c=1 at a timestep t−2 is p(2|1)α[t−2][2][1].

The possibility of this being a transition from a unit series xⱼ of length k=3 and class c=1 at a timestep t−2 is p(2|1)α[t−2][3][1].

The possibility of transition from a unit series xⱼ of length k=1 and class c=2 in a timestep t−2 is p(2|2)α[t−2][1][2].

The possibility of this being a transition from a unit series xⱼ of length k=2 and class c=2 at a timestep t−2 is p(2|2)α[t−2][2][2].

The possibility of this being a transition from a unit series xⱼ of length k=3 and class c=2 at a timestep t−2 is p(2|2)α[t−2][3][2].

By performing such calculations in a forward direction through dynamic programming based on a probability α[0][*][*], every probability α[t][k][c] can be determined.

Here, for example, it is assumed that a unit series xⱼ of length k=2 and class c=2 is determined at a timestep t−3. In this case, since length k=2, transition to the unit series xⱼ is possible by any unit series xⱼ at a timestep t−5, and this can be determined on the basis of its probability α[t−5][*][*].

By performing backward sampling based on the probability α[t][k][c] in this way, length k and class c of every unit series xⱼ can be determined.

Next, a blocked Gibbs sampler (BGS) is executed that estimates the length k of the unit series xⱼ used to segment the observation series S and the class c of each respective unit series xⱼ through sampling.

With a BGS, in order to perform efficient calculation, the length k of the unit series xᵢ used for segmenting an observation series S and the class c of each unit series xⱼ can be sampled together.

With a BGS, parameters N(c_{n,j}) and N(c_{n,j}, c_{n,j+1}), which are used when a transition probability is calculated from equation (13) described later, are specified through FFBS described later.

For example, the parameter N(c_{n,j}) represents the number of segments belonging to a class c_{n,j}, and the parameter N(c_{n,j},c_{n,j+1}) represents the number of times a transition from the class c_{n,j} to a class c_{n,j+1} has occurred. Moreover, with a BGS, the parameters N(c_{n,j}) and N(c_{n,j}, c_{n,j+1}) are specified as current parameters N(c′) and N(c′,c).

In FFBS, the length k of the unit series xⱼ used for segmenting the observation series S and the class c of each unit series xⱼ are both regarded as hidden variables and are sampled simultaneously.

In FFBS, the probability α[t][k][c] of a unit series xⱼ having a length k being classified into class c is determined with a timestep t as an endpoint.

For example, the probability α[t][k][c] of a segment s′_{t-k:k} (=p′ₜ₋ₖ, p′ₜ₋ₖ₊₁, . . . , p′ₖ) based on a vector p′ belonging to a class c can be determined by computing the following equation (7).

$${α [ t ] [ k ] [ c ] = P ( s ’}_{t - k : k} \vert {X}_{c} ) \times {{\sum }^{K}}_{k ’ = 1} {{\sum }_{c ’ = 0}}^{C} p ( c \vert c ’ ) α [ t - k ] [ k ’ ] [ c ’ ] \qquad ( 7 )$$

In equation (7), C is the number of classes and K is the maximum length of a unit series. P(s′_{t-k:k}|X_{c}) is the probability of a segment s′_{t-k:k} being generated from a class c, and is determined by the following equation (8).

$${{P ( s ’}_{t - k : k} \vert {X}_{c} ) = GP ( s ’}_{t - k : k} \vert {X}_{c} ) {P}_{len} ( k \vert λ ) \qquad ( 8 )$$

Pₗₑₙ(k|λ) of equation (8) is a Poisson distribution with a mean λ and the probability distribution of the segment length. Moreover, p(c|c′) of equation (11) represents the transition probability of a class, and is determined by equation (9) below.

$$p ( c \vert c ’ ) = \frac{N ( c ’ , c ) + α}{N ( c ’ ) + C α} \qquad ( 9 )$$

In equation (9), N(c′) represents the number of segments belonging to a class c′, and N(c′,c) represents the number of times a transition from a class c′ to a class c has occurred. As these, parameters N(c_{n,j}) and N(c_{n,j},c_{n,j+1}) specified by the BGS are used. Moreover, k′ represents the length of the segment before the segment s′_{t-k:k}, and c′ represents the class of the segment before the segment S′_{t-k:k}, and all lengths k and classes c in equation (7) are marginalized.

When t−k<0, the probability α[t][k][*]=0, and the probability α[0][0][*]=1.0. Equation (7) is a recurrence formula, and by performing calculation based on the probability α[1][1][*], all patterns can be calculated through dynamic programming.

By sampling the length and class of the unit series in a backward direction in accordance with the forward probability α[t][k][c] calculated as described above, it is possible to determine the length k of the unit series xⱼ used for segmenting the observation series S and the classes c of the respective unit series xⱼ.

The configuration illustrated in FIG. 1 for performing the computation in parallel in a Gaussian process described above will be explained.

The likelihood-matrix calculating unit 101 determines a log-likelihood through likelihood calculation of a Gaussian distribution.

Specifically, the likelihood-matrix calculating unit 101 determines a predicted value μₖ at each timestep and variance σₖ of the predicted values through a Gaussian process for a length k (k=1, 2, . . . , K′). Here, K′ is an integer of two or more.

Next, the likelihood-matrix calculating unit 101 assumes a Gaussian distribution and determines a probability p_{k,t} of an observation value yₜ at each timestep t (t=1, 2, . . . , T) being generated from the generated μₖ and σₖ. T is an integer of two or more. Here, the likelihood-matrix calculating unit 101 determines a probability p_{k,t} for every combination of length k of the unit series and timesteps t, and determines a log-likelihood matrix D1.

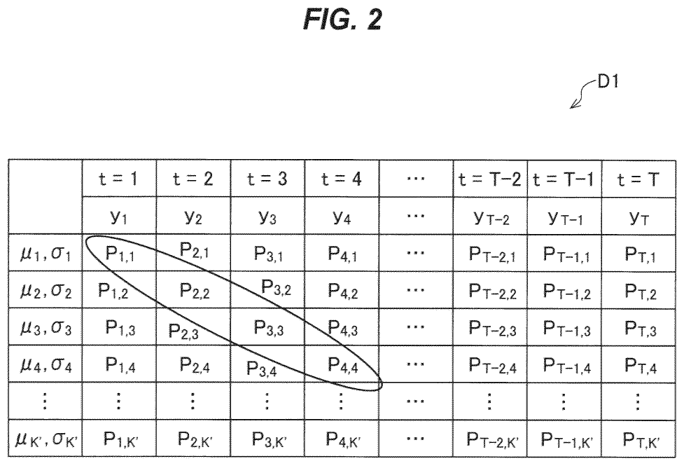

FIG. 2 is a schematic diagram illustrating an example of a log-likelihood matrix D1.

As illustrated in FIG. 2, the log-likelihood matrix D1 is a matrix in which the log-likelihoods for all combinations of predicted values μₖ for respective length k and variances σₖ of the predicted values μₖ are arranged in ascending order of the lengths k of the unit series predetermined to divide a time series of a predetermined event and timesteps t up to a maximum length K′, where the log-likelihoods are obtained by converting likelihoods that are probabilities of observation values yₜ, which are values obtained from the event at the respective timestep t.

The storage unit 102 stores information necessary for processing by the information processing device 100. For example, the storage unit 102 stores the log-likelihood matrix D1 calculated by the likelihood-matrix calculating unit 101.

The matrix-rotation operating unit 103 rotates the log-likelihood matrix D1 in order to achieve parallel computation.

For example, the matrix-rotation operating unit 103 acquires the log-likelihood matrix D1 from the storage unit 102. The matrix-rotation operating unit 103 then rotates the components of each row in the direction of the column of the log-likelihood matrix D1 in accordance with a predetermined rule to generate a rotated log-likelihood matrix D2. The rotated log-likelihood matrix D2 is stored in the storage unit 102.

Specifically, the matrix-rotation operating unit 103 functions as a first matrix shifting unit that performs a shifting process on the log-likelihood matrix D1 so that the log-likelihoods of when the lengths k and the timesteps t are each increased one unit are arranged in ascending order of the lengths k, and shifts the log-likelihoods other than those at the beginning of the lines. The matrix-rotation operating unit 103 generates the rotated log-likelihood matrix D2 as a shifted log-likelihood matrix from the log-likelihood matrix D1 through shift difference processing.

The matrix-rotation operating unit 103 rotates a successive-generation probability matrix D3 described later in order to achieve parallel computation.

For example, the matrix-rotation operating unit 103 acquires the successive-generation probability matrix D3 from the storage unit 102. The matrix-rotation operating unit 103 then rotates the components of each row in the direction of the column of the successive-generation probability matrix D3 in accordance with a predetermined rule to generate a rotated successive-generation probability matrix D4. The rotated successive-generation probability matrix D4 is stored in the storage unit 102.

Specifically, the matrix-rotation operating unit 103 functions as a second matrix shifting unit that shifts the successive generation probabilities so that the destinations and the sources of the components whose values have been shifted in the shifting process regarding the log-likelihood matrix D1 are reversed in the successive-generation probability matrix D3, to generate the rotated successive-generation probability matrix D4, which is a shifted successive-generation probability matrix.

In the log-likelihood matrix D1, since lengths k are arranged in the row direction and timesteps t are arranged in the column direction as illustrated in FIG. 2, the matrix-rotation operating unit 103 shifts the log-likelihoods toward the direction in which the timesteps t become smaller by the column number corresponding to a value equal to the row number minus one in each row of the log-likelihood matrix D1. The matrix-rotation operating unit 103 shifts the successive generation probabilities in the direction in which the timesteps t become greater by the column number corresponding to a value equal to the row number minus one in each row of the successive-generation probability matrix D3.

The successive-generation-probability parallel-computation unit 104 calculates probabilities GP successively generated through a Gaussian process from a time corresponding to a certain timestep in the same column by using the rotated log-likelihood matrix D2.

For example, the successive-generation-probability parallel-computation unit 104 retrieves the rotated log-likelihood matrix D2 from the storage unit 102, and sequentially adds the values of the respective row starting from the first row in each column, to generate the successive-generation probability matrix D3. The successive-generation probability matrix D3 is stored in the storage unit 102.

Specifically, the successive-generation-probability parallel-computation unit 104 functions as a successive-generation-probability calculating unit that generates a successive-generation probability matrix by adding the log-likelihoods from the beginning of each line to the respective components in the direction of the column in the rotated log-likelihood matrix D2 to calculate the successive generation probability of each component and using the calculated results as components.

The forward-probability sequential-parallel-computation unit 105 uses the rotated successive-generation probability matrix D4 stored in the storage unit 102 to sequentially calculates forward probabilities P_{forward} for the times corresponding to the timesteps.

For example, the forward-probability sequential-parallel-computation unit 105 retrieves the rotated successive-generation probability matrix D4 from the storage unit 102, and determine the forward probabilities P_{forward} by multiplies each column by a probability p(cκ′) of transition from a class c′ to a class c, determines a marginal probability of k step before, and sequentially adds this to the current timestep t. Here, the marginal probability is the sum of probabilities for all unit series lengths and classes.

Specifically, the forward-probability sequential-parallel-computation unit 105 functions as a forward-probability calculating unit that calculates forward probabilities by using values obtained by adding up the successive generation probabilities to the respective components in ascending order of length k for each timestep t in the rotated successive-generation probability matrix D4.

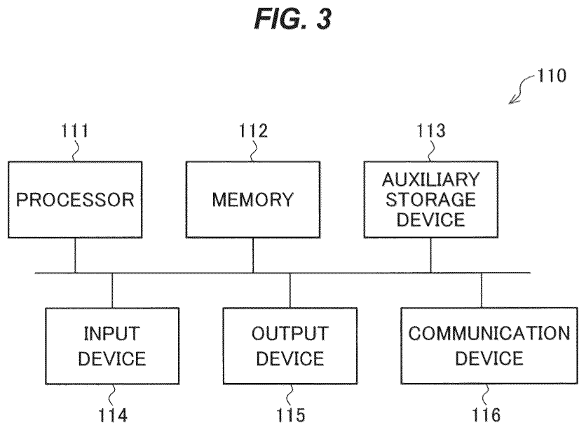

The information processing device 100 described above can be implemented by, for example, a computer 110 as illustrated in FIG. 3.

The computer 110 includes a processor 111, such as a central processing unit (CPU), a memory 112, such as a random access memory (RAM), an auxiliary storage device 113, such as a hard disk drive (HDD), an input device 114 that functions as an input unit, such as a keyboard, a mouse, or a microphone, an output device 115, such as a display or a speaker, and a communication device 116, such as a network interface card (NIC) for connecting to a communication network.

Specifically, the likelihood-matrix calculating unit 101, the matrix-rotation operating unit 103, the successive-generation-probability parallel-computation unit 104, and the forward-probability sequential-parallel-computation unit 105 can be implemented by loading programs stored in the auxiliary storage device 113 into the memory 112 and executing them by the processor 111.

The storage unit 102 can be implemented by the memory 112 or the auxiliary storage device 113.

Such programs may be provided over a network or may be recorded and provided on a recording medium. That is, such programs may be provided, for example, as a program product.

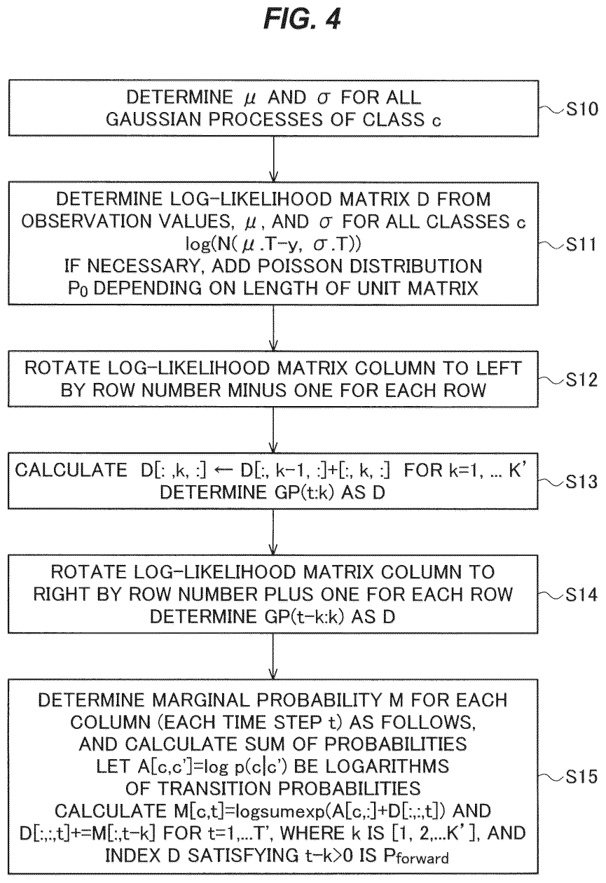

FIG. 4 is a flowchart illustrating operation by the information processing device 100.

First, the likelihood-matrix calculating unit 101 determines predicted values μₖ at respective timesteps t and variances σₖ of each predicted values for lengths k (k=1, 2, . . . , K′) through a Gaussian process of all classes c (step S10).

Next, the likelihood-matrix calculating unit 101 determines probabilities p_{k,t} of observed values yₜ at the respective timesteps t being generated from μₖ and σₖ generated in step S10. Here, the probabilities p_{k,t} assume a Gaussian distribution, and are lower the further away from μₖ. Here, the likelihood-matrix calculating unit 101 determines the probabilities p_{k,t} for all combinations of the lengths k of the unit series and the timesteps t, converts the acquired probabilities p_{k,t} into logarithms, and associates the acquired logarithms with the lengths k and the timesteps t used for the calculation, to determine the log-likelihood matrix D1 (step S11).

Specifically, the predicted values and variances of all timesteps are μ=(μ₁, μ₂, . . . , μ_{K′}) and σ=(σ₁, σ₂, . . . , σ_{K′}), respectively. A function to find the successive generation probabilities of a Gaussian distribution is denoted by N, and a function to find logarithms is denoted by log. In such a case, the likelihood-matrix calculating unit 101 can obtain the log-likelihood matrix D1 through parallel computation by the following equation (10).

Log(N(μ·T−y,σ·T)) (10)

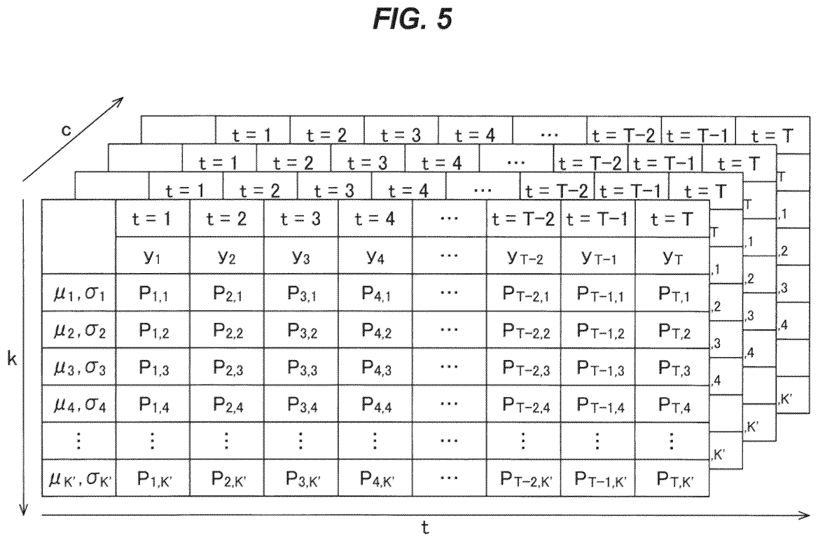

The likelihood-matrix calculating unit 101 determines a log-likelihood matrix D1 such as that illustrated in FIG. 2 for all classes c, to determine a multidimensional array of log-likelihood matrices D1 as illustrated in FIG. 5. As illustrated in FIG. 5, the multidimensional array of log-likelihood matrices D1 is a multidimensional matrix of length k as Gaussian process raw growth, timestep t as a step of time, and class c as state. Then, the likelihood-matrix calculating unit 101 stores the multidimensional array of log-likelihood matrices D1 in the storage unit 102.

Next, the matrix-rotation operating unit 103 retrieves, one by one in order, a log-likelihood matrix D1 from the multidimensional array of log-likelihood matrices D1 in the storage unit 102, and in the retrieved log-likelihood matrix D1, shifts the values of components corresponding to columns in the respective rows to components in columns to the left by a value equal to the row number minus one, to generate a rotated log-likelihood matrix D2 obtained by rotating the log-likelihood matrix D1 to the left (step S12). Then, the matrix-rotation operating unit 103 stores the rotated log-likelihood matrix D2 in the storage unit 102. In this way, a multidimensional array of rotated log-likelihood matrices D2 is stored in the storage unit 102.

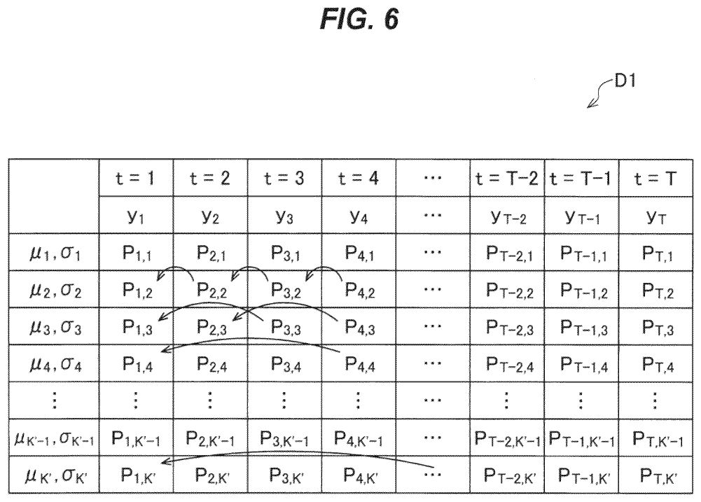

FIG. 6 is a schematic diagram for explaining left rotation operation by the matrix-rotation operating unit 103.

In the row of μ₁ and σ₁ whose row number is one, i.e., k=1, the matrix-rotation operating unit 103 does not perform rotation because (row number−1)=0.

In the row of μ₂ and σ₂ whose row number is two, i.e., k=2, the matrix-rotation operating unit 103 shifts the component values of the respective columns to the components of the columns immediately to the left because (row number−1)=1.

In the row of μ₃ and σ₃ whose row number is three, i.e., k=3, the matrix-rotation operating unit 103 shifts the component values of the respective columns to the components of the columns two columns down to the left because (row number−1)=2.

The matrix-rotation operating unit 103 repeats a similar process up to the last row, i.e., k=K′.

In this way, in the rotated log-likelihood matrix D2, the logarithms of the probabilities p_{k,t} are stored in chronological order indicated by the timesteps starting from the timestep t stored in the top row in each column.

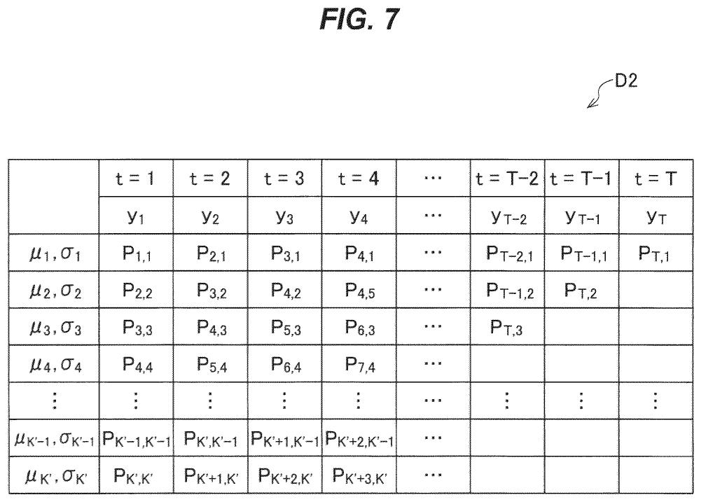

FIG. 7 is a schematic diagram illustrating an example of a rotated log-likelihood matrix D2.

Referring back to FIG. 4, the successive-generation-probability parallel-computation unit 104 then retrieves, one by one in order, a rotated log-likelihood matrix D2 from the multidimensional array of rotated log-likelihood matrices D2 stored in the storage unit 102, and calculates successive generation probabilities by adding the values from the top row to the target row in the respective columns in the retrieved rotated log-likelihood matrix D2 (step S13).

Here, for example, in the column of timestep t=1 of a rotated log-likelihood matrix D2, as illustrated in FIG. 7, a log-likelihood P_{1,1} corresponding to the top row k=1 (μ₁, σ₁) and the timestep t=1, a log-likelihood P_{2,2} corresponding to the next row k=2 (μ₂, σ₂) and the timestep t=2, a log-likelihood P_{3,3} corresponding to the next row k=3 (μ₃, σ₃) and the timestep t=3, . . . are stored in chronological order indicated by the timesteps t. This means, for example, that the log-likelihoods enclosed by the ellipse in FIG. 2 are arranged in a row. Therefore, the successive-generation-probability parallel-computation unit 104 can add the probabilities to each row to determine a successive generation probability, which is a probability of a Gaussian process corresponding to each row being generated successively from the timestamp at the top of each column. In other words, the successive-generation-probability parallel-computation unit 104 sequentially adds the component values of the rotated log-likelihood matrix D2 to each row (k=1, 2, . . . , K′) in the row direction as in equation (11) below, to perform parallel computation of the probabilities successively generated from a certain timestep.

$$D [ : , k , : ] ← D [ : , k - 1 , : ] + [ : , k , : ] \qquad ( 11 )$$

Here, the operation “:” indicates that parallel computation is performed for class c, unit series length k, and timestep t.

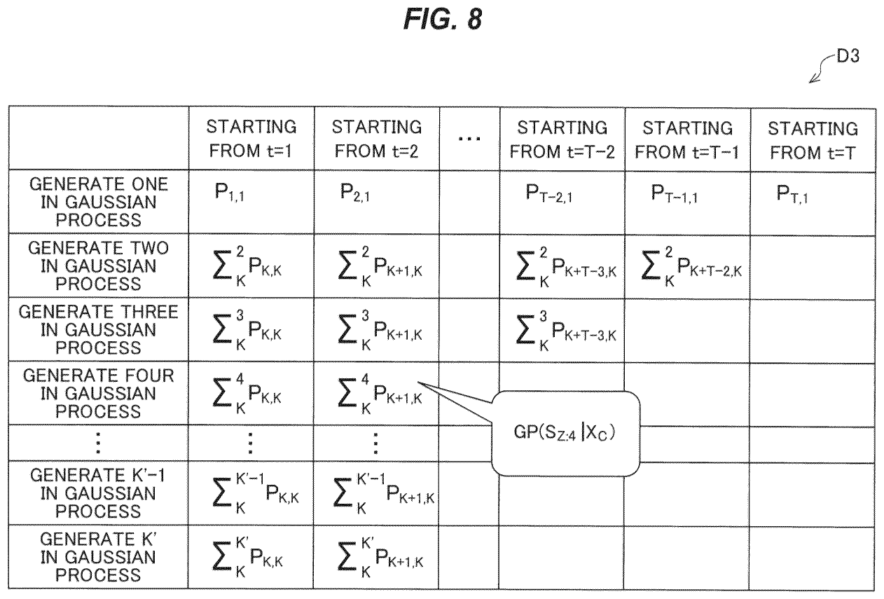

In step S13, a successive-generation probability matrix D3 is generated, as illustrated in FIG. 8.

This is equivalent to the probability GP (S_{t:k}|X_{c}) described later.

The successive-generation-probability parallel-computation unit 104 stores the multidimensional array of successive-generation probability matrices D3 in the storage unit 102.

Referring back to FIG. 4, the matrix-rotation operating unit 103 retrieves, one by one in order, a successive-generation probability matrix D3 from the multidimensional array of successive-generation probability matrices D3 in the storage unit 102, and in the retrieved successive-generation probability matrix D3, shifts the values of components corresponding to columns in the respective rows to components in columns to the right by a value equal to the row number minus one, to generate a rotated successive-generation probability matrix D4 obtained by rotating the successive-generation probability matrix D3 to the right (step S14). Step S14 corresponds to a process of undoing the left rotation in step S12. Then, the matrix-rotation operating unit 103 stores the rotated successive-generation probability matrix D4 in the storage unit 102. In this way, the multidimensional array of rotated successive-generation probability matrices D4 is stored in the storage unit 102.

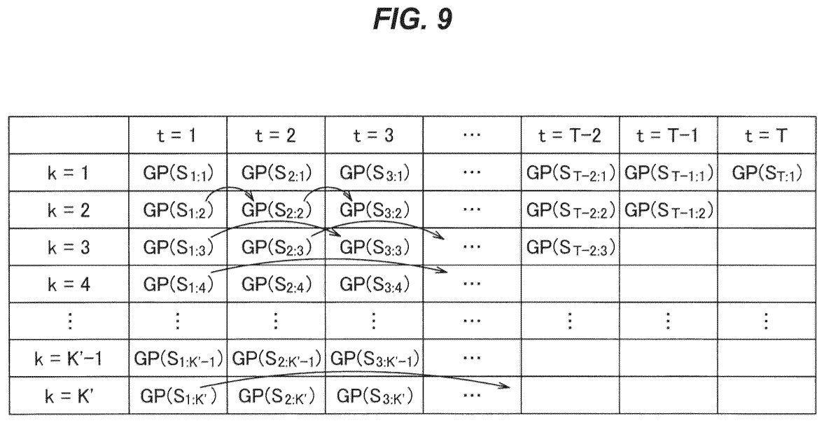

FIG. 9 is a schematic diagram for explaining right rotation operation by the matrix-rotation operating unit 103.

In the row of μ₁ and σ₁ whose row number is one, i.e., k=1, the matrix-rotation operating unit 103 does not perform rotation because (row number−1)=0.

In the row of μ₂ and σ₂ whose row number is two, i.e., k=2, the matrix-rotation operating unit 103 shifts the component values of the respective columns to the components of the columns immediately to the right because (row number−1)=1.

In the row of μ₃ and σ₃ whose row number is three, i.e., k=3, the matrix-rotation operating unit 103 shifts the component values of the respective columns to the components of the columns two columns down to the right because (row number−1)=2.

The matrix-rotation operating unit 103 repeats a similar process up to the last row, i.e., k=K′.

In this way, in a rotated successive-generation probability matrix D4, GP (S_{t:k}|X_{c}) is rearranged as GP (S_{t-k:k}|X_{c}). As a result, P_{forward} in the FFBS in the above equation (11) can be determined through parallel computation for each column of the rotated successive-generation probability matrix D4.

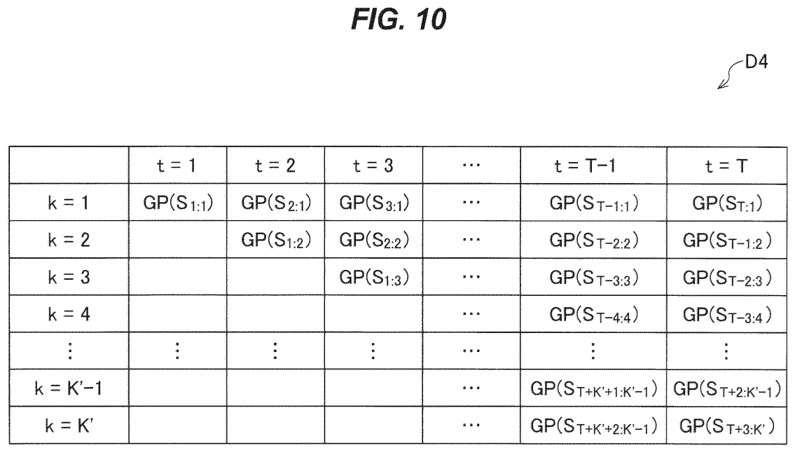

FIG. 10 is a schematic diagram illustrating an example of a rotated successive-generation probability matrix D4.

Referring back to FIG. 4, next, the forward-probability sequential-parallel-computation unit 105 retrieves, one by one in order, a rotated successive-generation probability matrix D4 from the multidimensional array of rotated successive-generation probability matrices D4 stored in the storage unit 102, in each retrieved rotated successive-generation probability matrix D4, multiplies each column corresponding to each timestep t by a probability p(c|c′) of transition from class c to class c′ of a Gaussian process, as in equation (12), to determine a marginal probability M and determine P_{forward} by calculating the sum of probabilities as in equation (13) below (step S15).

$$M [ c , t ] = log sum exp ( A [ c , : ] + D [ : , : , t ] ) \qquad ( 12 )$$

$$D [ : , : , t ] += M [ : , t - k ] \qquad ( 13 )$$

Here, the determined D is P_{forward}. In this way, parallel computation is achieved for each dimension of the multidimensional array other than the timesteps t.

In other words, the storage unit 102 stores the respective log-likelihood matrices D1 in multiple dimensions corresponding to multiple classes of the unit series. Then, the forward-probability sequential-parallel-computation unit 105 can execute processing in parallel for the respective dimensions of the multidimensional array other than the timesteps t.

Through steps S10 to S15 above, the matrix-rotation operating unit 103 rearranges the matrix before the calculation of successive generation probabilities and the calculation of forward probabilities, so that parallel computation can be applied to the conventional algorithm for sequentially determining P_{forward} for every class c, unit series length k, and timestep t. Therefore, efficient processing can be executed and processing can be accelerated.

In the above embodiment, an example of implementing parallel computation by rotation of a multidimensional array or rearrangement in the memory is described, but this is an example for parallelizing computation. For example, computation can be easily executed by reading reference addresses of a matrix by shifting the reference addresses by a column number without rearrangement in the memory, and using the retrieved values for computation. Such a method is also included in the scope of the present embodiment. Specifically, when the log-likelihood matrix D1 illustrated in FIG. 4 is given, addresses may be retrieved from the first column in the row μ₁, σ₁, from the second column in the row μ₂, σ₂, and from the Nth column in the row μ_{N}, σ_{N}, and parallel computation may be performed for the values obtained by shifting the retrieved addresses by one column.

Although rotation in the row direction has been described as an example in the disclosure, rotation in the column direction may be performed in the case of a likelihood matrix having timesteps t arranged in the row direction and unit series lengths k arranged in the column direction.

Specifically, when lengths k are arranged in the row direction and timesteps t are arranged in the column direction in the log-likelihood matrix D1, the matrix-rotation operating unit 103 shifts the log-likelihoods toward the direction in which the timesteps t become smaller by the row number corresponding to a value equal to the column number minus one in each row of the log-likelihood matrix D1. The matrix-rotation operating unit 103 shifts the successive generation probabilities in the direction in which the timesteps t become greater by the row number corresponding to a value equal to the column number minus one in each column of the successive-generation probability matrix D3.

The above embodiment describes the method of calculating forward probabilities by determining a predicted value μₖ and a variance σₖ for each timestep k using a Gaussian process. On the other hand, the calculation method of the predicted value μₖ and the variance σₖ is not limited to a Gaussian process. For example, if multiple sequences of observation values y are given for each class c by a blocked Gibbs sampler, a predicted value μₖ and variance σₖ may be determined for each timestep k for these sequences. In other words, the predicted value μₖ may be an expected value calculated by a blocked Gibbs sampler.

Alternatively, a predicted value μₖ and a variance value σₖ may be acquired for each class c by a recurrent neural network (RNN) to which uncertainty is introduced by applying dropouts. In other words, the predicted value μₖ may be a value predicted by an RNN in which uncertainty is introduced by applying dropouts.

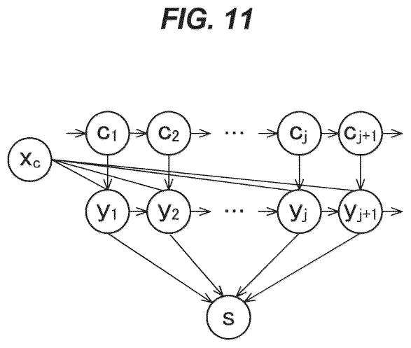

FIG. 11 is a schematic diagram illustrating a graphical model using unit series xⱼ of an observation series S, classes cⱼ of the unit series xⱼ, and a parameter X_{c} of a Gaussian process of the classes c in the above Gaussian process.

The observation series S is generated by combining the unit series xⱼ.

The parameter X_{c} of the Gaussian process is a set of unit series x classified into classes c, and the number of segments J is an integer representing the number of unit series x obtained by segmenting the observation series S. Here, it is assumed that time series data is generated through a hidden semi-Markov model whose output distribution is a Gaussian process. Then, by estimating the parameter X_{c} of the Gaussian process, it becomes possible to segment the observation series S into unit series xⱼ and classify each unit series Xⱼ into each class c.

For example, each class c has a parameter X_{c} of a Gaussian process, and the output value xᵢ at a timestep I of a unit series is learned for each class through Gaussian process regression.

In the conventional technique regarding the above-described Gaussian process, every one of the multiple observation series Sₙ (n=1 to N, where n is an integer of one or more and N is an integer of two or more) is randomly segmented and classified in the initialization step, and then optimally segmented into unit series xⱼ and classified into each class c by repeating BGS processing, forward filtering, and backward sampling.

Here, in the initialization step, every observation series Sₙ is divided into unit series xⱼ having random lengths, and a class c is randomly assigned to each unit series xⱼ, to obtain X_{c}, which is the set of unit series x classified into a class c. In this way, the observation series S is randomly segmented into unit series Xⱼ and classified into each class c.

In BGS processing, all unit series xⱼ obtained by segmenting a randomly divided observation series Sₙ are omitted from the parameters X_{c} of the Gaussian process because it is assumed that that portion of the observation series Sₙ has not been observed.

In forward filtering, the observation series Sₙ that has been omitted from the Gaussian process is generated from the Gaussian process learned with the omitted observation series Sₙ. A probability P_{forward} of a successive series being generated at a certain timestep t and the corresponding separators being generated from a class is determined by equation (14) below. This equation (14) is the same as equation (7) above.

$${p}_{forward} [ t ] [ k ] [ c ] = GP ( {s}_{t - k : k} \vert {X}_{c} ) {P}_{O} ( λ , k ) {\sum }_{k ’ = 1}^{k ’} {\sum }_{c ’ = 1}^{c ’} ( p ( c \vert c ’ ) {p}_{forward} [ t - k ] [ k ’ ] [ c ’ ] ) \qquad ( 14 )$$

$$( p ( c \vert c ’ ) = \frac{{N}_{c ’ , c} + α}{{N}_{c ’} + C ’ α}$$

Here, c′ is a class number, K′ is the maximum length of a unit series, Po(λ,k) is a Poisson distribution giving the length k of the unit series for a mean length λ where the separation occurs, N_{c′,c} is the number of transitions from a class c′ to class c, and α is a parameter. In this calculation, for each class c, the probability of a unit series x of k times being successively generated from the same Gaussian process, starting from every timesteps t, is determined as GP (S_{t-k:k}|X_{c})Po(λ, k).

In backward sampling, sampling of length k and class c of the unit series xⱼ is repeated backward from the timestep t=T on the basis of forward probabilities P_{forward}.

In forward filtering, there are two causes that decreases processing speed. The first cause is that inference of the Gaussian process and calculation of the likelihoods of the Gaussian distribution are performed one by one at each timestep t. The second cause is that the sum of the probabilities is repeatedly determined each time a timestep t, a length k, or a class c of a unit series xⱼ is changed.

In order to speed up the processing, attention is paid to GP (S_{t-k:k}|X_{c}) in equation (14).

The inference range of the Gaussian process in the forward filtering is up to the maximum K′, and it is necessary to calculate the log-likelihoods of the Gaussian distribution for all ranges in order to calculate equation (14). This is used to increase the processing speed. Here, the inference result (likelihoods) by the Gaussian process of the lengths k of the unit series xⱼ is determined by likelihood calculation of a Gaussian distribution for all combinations of the lengths k of the unit series and the timesteps t. The matrix of the determined likelihoods is illustrated in FIG. 2.

Here, when this matrix is viewed diagonally, it can be noticed that the result of the likelihoods P of the Gaussian process is arranged diagonally when the timesteps t and the lengths k of the unit series xⱼ are both advanced one. That is, as illustrated in FIG. 6, by rotating the component values in each row by the row number minus k to the left in the column direction and adding each column together, the probabilities of consecutive generation by the Gaussian process for k times can be determined through parallel computation starting from all timesteps t. The values determined through this computation corresponds to the probabilities GP (S_{t-k:k}|X_{c}).

Then, in order to determine the P_{forward} at a timestep t from equation (14), the probabilities GP(S_{t-k:k}|X_{c}) retroactive to the lengths k of the unit series xⱼ are required. That is, as illustrated in FIG. 9, by rotating the component values in each row of the GP(S_{t:k}|X_{c}) matrix to the right in the column direction by the row number minus one, the data arranged at the timestep t (i.e., the column t) becomes the probabilities GP (S_{t-k:k}|X_{c}) necessary for determining P_{forward}.

Next, in the conventional technique regarding the Gaussian process, the following equation (15) is calculated for all timesteps t, lengths k of unit series xⱼ, and classes c.

$${\sum }_{k ′ = 1}^{K ′} {\sum }_{c ′ = 1}^{C ′} ( p ( c \vert {c}^{″} ) {P}_{forward} [ t - k ] [ {k}^{′} ] [ {c}^{′} ] ) \qquad ( 15 )$$

In contrast, in the present embodiment, by adding p(c|c′) to the GP (S_{t-k:k}|X_{c}) matrix at each timestep t and determining the probability sum for lengths k′ of unit series xⱼ and classes c′ with “log sumexp,” it is possible to perform parallel computation for the lengths k′ of unit series xⱼ and classes c′. Furthermore, the value calculated from the following equation (16), which is the result of the computation, can be stored and used to calculate P_{forward} in the future to improve efficiency.

$$M [ t - k ] {\sum }_{k ′ = 1}^{K ′} {\sum }_{c ′ = 1}^{C ′} ( p ( c \vert {c}^{″} ) {P}_{forward} [ t - k ] [ {k}^{′} ] [ {c}^{′} ] ) \qquad ( 16 )$$

In the conventional technique regarding the Gaussian process, the calculation is repeated for three variables, i.e., class c, and timestep t and length k of the unit series xⱼ for forward filtering, and since the calculation is performed for each variable, the calculation takes time.

In contrast, in the present embodiment, since log-likelihoods for lengths k of all unit series xⱼ and timesteps t are determined through the likelihood calculation of the Gaussian distribution, the result is saved as a matrix in the storage unit 102, and the calculation of P_{forward} is parallelized by shifting the matrix, it is possible to achieve high-speed processing of the likelihood calculation of the Gaussian process. This is expected to reduce the time required to tune hyperparameters and enable real-time analysis of operations at assembly sites.

What is claimed is:

1. An information processing device comprising:
a processor to execute a program; and
a memory to store the program which, when executed by the processor, performs processes of,
storing a log-likelihood matrix in which log-likelihoods are arranged as components in ascending order of lengths of unit series predetermined to divide a time series of a predetermined event and timesteps for combinations of predicted values predicting the event for each length up to a maximum length and variances of the predicted values, the log-likelihoods being obtained by converting likelihoods into logarithms, the likelihoods being probabilities of observation values obtained from the event at the respective timesteps being generated;
generating a shifted log-likelihood matrix by performing a shifting process of shifting the log-likelihoods other than log-likelihoods at the top of each line in the log-likelihood matrix in such a manner that the log-likelihoods are aligned along each line in ascending order of the lengths when the lengths and the timesteps are each increased by one unit;
generating a successive-generation probability matrix by adding the log-likelihoods from the top of each of the lines to the respective components in the shifted log-likelihood matrix, to calculate successive generation probabilities of the respective components;
generating a shifted successive-generation probability matrix by shifting the successive generation probabilities in the successive-generation-probability matrix in such a manner that shift destinations and shift sources of components whose values have been shifted through the shifting process are reversed; and
calculating a forward probability of a unit series having a certain length to be classified into a certain class with a certain timestep being an endpoint by using a value obtained by adding the successive generation probabilities up to the respective components in ascending order of the lengths at the respective timesteps in the shifted successive-generation probability matrix.

2. The information processing device according to claim 1, wherein,
when the lengths are arranged in a row direction and the timesteps are arranged in a column direction in the log-likelihood matrix, the processor shifts the log-likelihoods in each row in a direction in which the timesteps decrease by a column number corresponding to a value obtained by subtracting one from a row number, and
the processor shifts the successive generation probabilities in each row in a direction in which the timesteps increase by the column number corresponding to a value obtained by subtracting one from the row number.

3. The information processing device according to claim 1, wherein,
when the lengths are arranged in a column direction and the timesteps are arranged in a row direction in the log-likelihood matrix, the processor shifts the log-likelihoods in each column in a direction in which the timesteps decrease by a row number corresponding to a value obtained by subtracting one from a column number, and
the processor shifts the successive generation probabilities in each row in a direction in which the timesteps increase by the row number corresponding to a value obtained by subtracting one from the column number.

4. The information processing device according to claim 1, wherein the predicted values are values determined through calculation of Gaussian distribution likelihood.

5. The information processing device according to claim 1, wherein the predicted values are expected values calculated with a blocked Gibbs sampler.

6. The information processing device according to claim 1, wherein the predicted values are predicted with a recurrent neural network with dropouts added to introduce uncertainty.

7. The information processing device according to claim 1, wherein,
the processor stores the log-likelihood matrix for each of a plurality of dimensions corresponding to a plurality of classes of the unit series, and
the processor executes processing in parallel in each of the dimensions other than the timesteps.

8. The information processing device according to claim 2, wherein,
the processor stores the log-likelihood matrix for each of a plurality of dimensions corresponding to a plurality of classes of the unit series, and
the processor executes processing in parallel in each of the dimensions other than the timesteps.

9. The information processing device according to claim 3, wherein,
the processor stores the log-likelihood matrix for each of a plurality of dimensions corresponding to a plurality of classes of the unit series, and
the processor executes processing in parallel in each of the dimensions other than the timesteps.

10. The information processing device according to claim 4, wherein,
the processor stores the log-likelihood matrix for each of a plurality of dimensions corresponding to a plurality of classes of the unit series, and
the processor executes processing in parallel in each of the dimensions other than the timesteps.

11. The information processing device according to claim 5, wherein,
the processor stores the log-likelihood matrix for each of a plurality of dimensions corresponding to a plurality of classes of the unit series, and
the processor executes processing in parallel in each of the dimensions other than the timesteps.

12. The information processing device according to claim 6, wherein,
the processor stores the log-likelihood matrix for each of a plurality of dimensions corresponding to a plurality of classes of the unit series, and
the processor executes processing in parallel in each of the dimensions other than the timesteps.

13. A non-transitory computer-readable storage medium storing a program that causes a computer to execute processes comprising:
storing a log-likelihood matrix in which log-likelihoods are arranged as components in ascending order of lengths of unit series predetermined to divide a time series of a predetermined event and timesteps for combinations of predicted values predicting the event for each length up to a maximum length and variances of the predicted values, the log-likelihoods being obtained by converting likelihoods into logarithms, the likelihoods being probabilities of observation values obtained from the event at the respective timesteps being generated;
generating a shifted log-likelihood matrix by performing a shifting process of shifting the log-likelihoods other than log-likelihoods at the top of each line in the log-likelihood matrix in such a manner that the log-likelihoods are aligned along each line in ascending order of the lengths when the lengths and the timesteps are each increased by one unit;
generating a successive-generation probability matrix by adding the log-likelihoods from the top of each of the lines to the respective components in the shifted log-likelihood matrix, to calculate successive generation probabilities of the respective components;
generating a shifted successive-generation probability matrix by shifting the successive generation probabilities in the successive-generation-probability matrix in such a manner that shift destinations and shift sources of components whose values have been shifted through the shifting process are reversed; and
calculating a forward probability of a unit series having a certain length to be classified into a certain class with a certain timestep being an endpoint by using a value obtained by adding the successive generation probabilities up to the respective components in ascending order of the lengths at the respective timesteps in the shifted successive-generation probability matrix.

14. An information processing method comprising:
using a log-likelihood matrix in which log-likelihoods are arranged as components in ascending order of lengths of unit series predetermined to divide a time series of a predetermined event and timesteps for combinations of predicted values predicting the event for each length up to a maximum length and variances of the predicted values, the log-likelihoods being obtained by converting likelihoods into logarithms, the likelihoods being probabilities of observation values obtained from the event at the respective timesteps being generated;
generating a shifted log-likelihood matrix by performing a shifting process of shifting the log-likelihoods other than log-likelihoods at the top of each line in the log-likelihood matrix in such a manner that the log-likelihoods are aligned along each line in ascending order of the lengths when the lengths and the timesteps are each increased by one unit;
generating a successive-generation probability matrix by adding the log-likelihoods from the top of each of the lines to the respective components in the shifted log-likelihood matrix, to calculate successive generation probabilities of the respective components;
generating a shifted successive-generation probability matrix by shifting the successive generation probabilities in the successive-generation-probability matrix in such a manner that shift destinations and shift sources of components whose values have been shifted through the shifting process are reversed; and
calculating a forward probability of a unit series having a certain length to be classified into a certain class with a certain timestep being an endpoint by using a value obtained by adding the successive generation probabilities up to the respective components in ascending order of the lengths at the respective timesteps in the shifted successive-generation probability matrix.
